(19) United States
(12) Patent Application Publication
(10) Pub. No.: US 2020/0172560 A1
(43) Pub. Date: Jun. 4, 2020

(54) PROCESS FOR PREPARATION OF CRISABOROLE

(71) Applicant: Glenmark Life Science Limited, Solapur (IN)

(72) Inventors: Shekhar Bhaskar Bhirud, Mumbai (IN); Samir Naik, Thane (IN); Amit Tewari, Lucknow (IN); Yogesh Baburao Kajale, Kalyan (IN); Mahendra Jorna Choraghe, NewPanvel (IN); Sanjay Sakharam Pawar, Navi Mumbai (IN)

(21) Appl. No.: 16/619,171

(22) PCT Filed: May 31, 2018
(86) PCT No.: PCT/IB2018/053883

§ 371 Date: Dec. 4, 2019

(30) Foreign Application Priority Data
Jun. 5, 2017 (IN) 201721019659

(51) Int. Cl. C07F 5/02

(52) U.S. Cl. CPC C07F 5/027

(57) ABSTRACT

The present invention relates to a process for the preparation of crisaborole, the process comprising reacting a compound of formula IIa with a compound of formula III to give a compound of formula IV and converting the compound of formula IV to crisaborole. The present invention also relates to a process for the preparation of crystalline crisaborole.

### PRIORITY

This application claims the benefit of Indian Provisional Application 201721019659 filed on Jun. 5, 2017, entitled “PROCESS FOR PREPARATION OF CRISABOROLE”, the contents of which are incorporated herein by reference.

### BACKGROUND OF THE INVENTION

### Technical Field

The present invention relates to a process for the preparation of crisaborole.

### Description of the Related Art

Crisaborole, also known as 5-(4-cyanophenoxy)-1,3-dihydro-1-hydroxy-benzoxaborole, is represented by the structure of formula I.

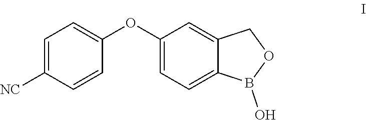 [SMILES: N#Cc1ccc(Oc2ccc3c(c2)COB3O)cc1]

Crisaborole is a phosphodiesterase 4 inhibitor indicated for topical treatment of mild to moderate atopic dermatitis in patients 2 years of age and older.

The processes known in the art for the preparation of crisaborole involve purification of crisaborole and intermediate compounds by column chromatography.

The use of chromatographic columns to isolate the intermediate compounds can be avoided. As column chromatography always requires the use of high amounts of organic eluants, its avoidance clearly contributes to the industrial applicability of the process in terms of improved product quality, lower manufacturing costs and easier ecological disposal of process waste. There is a need in the art, therefore, for industrially applicable processes for the preparation of crisaborole which avoid tedious and time-consuming column chromatography.

The object of the present invention is to provide a process for the preparation of crisaborole avoiding column chromatography for purification of crisaborole and intermediate compounds.

### SUMMARY OF THE INVENTION

The present invention provides a process for the preparation of crisaborole, a compound of formula

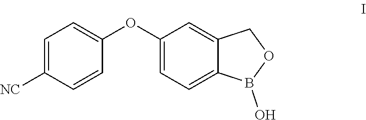 [SMILES: N#Cc1ccc(Oc2ccc3c(c2)COB3O)cc1]

the process comprising:
(a) reacting a compound of formula IIa,

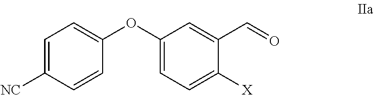

wherein X is selected from the group consisting of Cl, Br, I, OMs, OTf, with a compound of formula III,

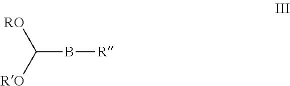

wherein, R″ is H, or B(OR)(OR′);
R and R′ are independently C₁₋₆ alkyl, aryl or R and R′ together with the oxygen atoms to which they are bonded join to form a 5- or 6-membered ring, wherein the 5- or 6-membered ring is optionally substituted with C₁₋₆ alkyl or fused with aryl, to give a compound of formula IV; and

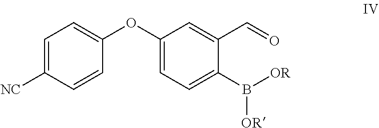

(b) reducing the compound of formula IV to give crisaborole, the compound of formula 1.

In another embodiment, the present invention provides a process for the preparation of crisaborole, the process comprising:
(a) dissolving crisaborole in an organic solvent to form a solution;
(b) optionally, adding a second solvent to the solution of step (a) to form a mixture;
(c) precipitating out crisaborole from the solution of step (a) or the mixture of step (b); and
(d) isolating crisaborole obtained in step (c).

### BRIEF DESCRIPTION OF THE DRAWINGS

FIG. 1 is a characteristic XRPD of crystalline crisaborole as obtained in Example 8.

FIG. 2 is a DSC thermogram of crystalline crisaborole as obtained in Example 8.

FIG. 3 is a characteristic XRPD of crystalline crisaborole as obtained in Example 10.

FIG. 4 is a DSC thermogram of crystalline crisaborole as obtained in Example 10.

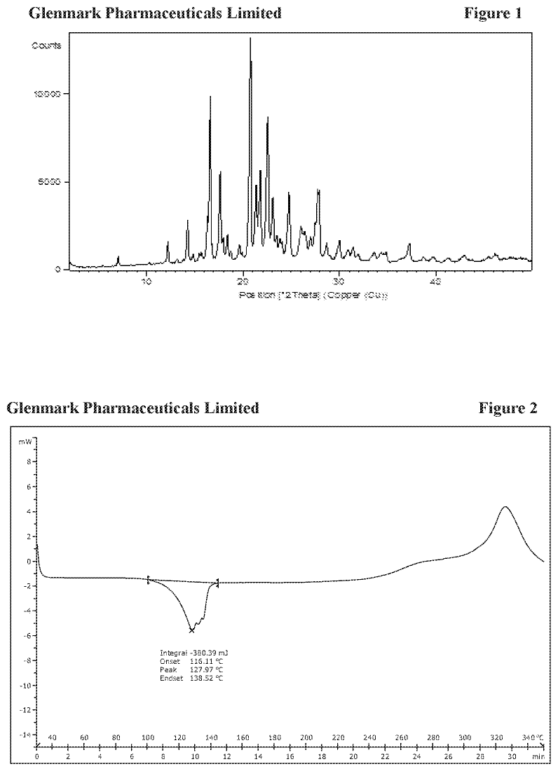

### DETAILED DESCRIPTION OF THE INVENTION

The present invention provides a process for the preparation of crisaborole, a compound of formula 1,

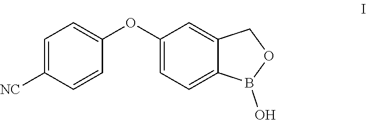 [SMILES: N#Cc1ccc(Oc2ccc3c(c2)COB3O)cc1]

the process comprising:
(a) reacting a compound of formula IIa,

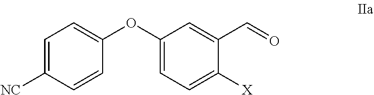

wherein X is selected from the group consisting of Cl, Br, I, OMs, OTf, with a compound of formula III,

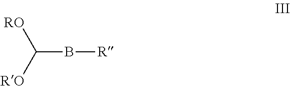

wherein, R″ is H, or B(OR)(OR′);
R and W are independently C₁₋₆ aryl, or R and R′ together with the oxygen atoms to which they are bonded join to form a 5- or 6-membered ring, wherein the 5- or 6-membered ring is optionally substituted with C₁₋₆ alkyl or fused with aryl, to give a compound of formula IV; and

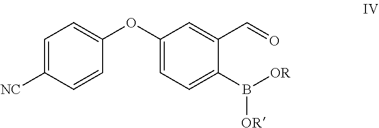

(b) reducing the compound of formula IV to give crisaborole, the compound of formula I.

In the present application, the term “room temperature” means a temperature of about 25° C. to about 30° C.

The term “C₁₋₆ alkyl” means alkyl groups having 1 to 6 carbon atoms and includes groups such as methyl, ethyl, n-propyl, isopropyl, n-butyl, isobutyl, tert-butyl, n-pentyl.

In (a) of the above process, the compound of formula IIa is reacted with the compound of formula III to give the compound of formula IV.

In one embodiment, the reaction may be carried out in the presence of a metal catalyst.

A suitable metal catalyst includes, but is not limited to tetrakis(triphenylphosphine)palladium [Pd(PPh₃)₄], bis(triphenylphosphine) palladium(II) chloride [PdCl₂(PPh₃)₂], [1,1′-bis(diphenylphosphino)ferrocene]dichloropalladium(II) [PdCl₂(dppf)]; palladium(II) acetate [Pd(OAc)₂], dichloridobis (triphenylphosphine)nickel(II) [NiCl₂(PPh₃)₂], 1,4-bis(diphenylphosphino)butane-palladium(II) chloride [PdCl₂(dppb)], or mixtures thereof.

In one embodiment, the reaction may be carried out in the presence of a base. The suitable base includes, but is not limited to alkali metal hydroxides such as lithium hydroxide, sodium hydroxide, potassium hydroxide; alkali metal carbonate such as sodium carbonate, potassium carbonate, caesium carbonate; alkali metal bicarbonate such as sodium bicarbonate, potassium bicarbonate; alkali metal acetates such as sodium acetate, potassium acetate; amines such as triethylamine, diisopropylethylamine; or mixtures thereof. Preferably the base selected is potassium acetate.

In one embodiment, the reaction may be carried out in the presence of a suitable solvent. The suitable solvent includes but is not limited to alcohols such as methanol, ethanol, n-propyl alcohol, isopropyl alcohol, n-butyl alcohol, isobutyl alcohol, sec-butyl alcohol, tert-butyl alcohol, pentanol, octanol and the like; esters such as methyl acetate, ethyl acetate, n-propyl acetate, test-butyl acetate and the like; ketones such as acetone, ethyl methyl ketone, methyl isobutyl ketone and the like; ethers such as dimethyl ether, diethyl ether, diisopropyl ether, tert-butyl methyl ether, dimethoxyethane, tetrahydrofuran, dioxane and the like; hydrocarbons such as toluene, xylene, chlorobenzene, heptane, hexane and the like; acetonitrile; dimethylformamide; dimethyl sulfoxide; water or mixtures thereof. Preferably the solvent selected is dioxane.

In one embodiment, the reaction may be carried out at a temperature of about 25° C. to about 100° C., preferably at about 60° C. to about 80° C.

In one embodiment, the compound of formula IIa is reacted with the compound of formula III, wherein R″ is B(OR)(OR′); and R and R′ together with the oxygen atoms to which they are bonded join to form a 5-membered ring substituted with C₁₋₆ alkyl to give a compound of formula IV.

In one embodiment, the compound of formula IIa is reacted with the compound of formula III, wherein R″ is B(OR)(OR′); and R and R′ together with the oxygen atoms to which they are bonded join to form a 5-membered ring as represented by the structure of formula IVb,

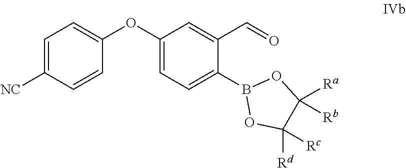

wherein R^{a}, R^{b}, R^{c}, R^{d} is H, or C₁₋₆ alkyl.

In one embodiment, the compound of formula IIa is reacted with the compound of formula III, wherein IV is B(OR)(OR′); and R and W together with the oxygen atoms to which they are bonded join to form a 5-membered ring substituted with C₁ alkyl groups to give a compound of formula IVa.

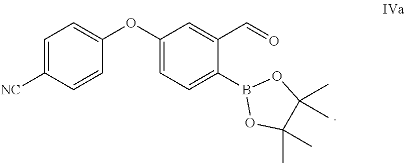 [SMILES: CC1(C)OB(c2ccc(Oc3ccc(C#N)cc3)cc2C=O)OC1(C)C]

In one embodiment, the compound of formula IIa, wherein X is Br, is reacted with the compound of formula III, wherein R″ is B(OR)(OR′); and R and W together with the oxygen atoms to which they are bonded join to form a 5-membered ring substituted with C₁ alkyl groups in the presence of PdCl₂(dppf) catalyst to give a compound of formula IVa.

In one embodiment, the reaction mixture of step (a) is worked up by involving one or more of the following steps:
(i) concentrating the reaction mixture, treating the residue with water and organic solvent, separating the two layers, and concentrating the organic layer to give the compound of formula IV;
(ii) treating the reaction mixture with water, and filtering the compound of formula IV;
(iii) treating the compound of formula IV obtained in step (i) or step (ii) with an organic solvent selected from the group consisting of alcohols, hydrocarbons, and mixtures thereof.

The organic solvent of step (i) may be selected from the group consisting of esters such as methyl acetate, ethyl acetate, n-propyl acetate, tort-butyl acetate and the like; ethers such as diethyl ether, diisopropyl ether, tert-butyl methyl ether, dioxane and the like. Preferably, the organic solvent selected is ethyl acetate.

The organic solvent of step (iii) may be selected from the group consisting of alcohols such as methanol, ethanol, n-propyl alcohol, isopropyl alcohol, n-butyl alcohol, isobutyl alcohol, sec-butyl alcohol, tert-butyl alcohol, n-pentyl alcohol, n-octyl alcohol and the like; hydrocarbons such as such as heptane, hexane and the like; and mixtures thereof. Preferably the organic solvent selected is isopropyl alcohol, heptane.

In one embodiment, the compound of formula IV is treated with a nonpolar solvent.

In one embodiment, the nonpolar solvent may be selected from the group consisting of hydrocarbons such as heptane, hexane, pentane, cyclohexane, toluene, xylene, and the like; halogenated hydrocarbons such as dichloromethane, chloroform, ethylene dichloride, and the like; ethers such as dimethyl ether, diethyl ether, diisopropyl ether, tetrahydrofuran, methtyltetrahydrofuran, dioxane, and the like; and mixtures thereof.

In one embodiment, the compound of formula IV is treated with a hydrocarbon solvent.

In one embodiment, the hydrocarbon solvent includes but is not limited to heptane, hexane, pentane, cyclohexane, toluene, xylene, and the like; or mixtures thereof.

In one embodiment, the compound of formula IV obtained by the process described herein, has a purity of ≥90%, as determined by HPLC.

In another embodiment, the compound of formula IV obtained by the process described herein, has a purity of ≥95%, as determined by HPLC.

In one embodiment, the compound of formula IVa is obtained in a purity of ≥90% and wherein the level of impurity A or impurity B is less than 0.5% w/w relative to the amount of the compound of formula IV, as determined by HPLC

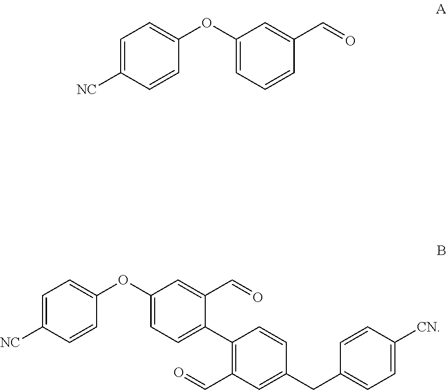 [SMILES: N#Cc1ccc(Oc2cccc(C=O)c2)cc1 ; N#Cc1ccc(Cc2ccc(-c3ccc(Oc4ccc(C#N)cc4)cc3C=O)c(C=O)c2)cc1]

In one embodiment, the present invention provides a compound of formula IV in a purity of as determined by HPLC, prepared by a process comprising treating the compound of formula IV with a hydrocarbon solvent.

The hydrocarbon solvent may be selected as discussed supra.

In one embodiment, the present invention provides a compound of formula IV in a purity of as determined by HPLC, prepared by a process comprising treating the compound of formula IV with a nonpolar solvent.

The nonpolar solvent may be selected as discussed supra.

In one embodiment, the compound of formula IV obtained by the process described herein, has a purity of ≥90%, as determined by HPLC, without use of column chromatography.

In one embodiment, the compound of formula IVa is obtained in a purity of ≥90% and wherein the level of impurity E is less than 0.5% w/w relative to the amount of the compound of formula IV, as determined by HPLC

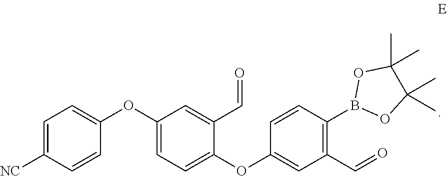 [SMILES: CC1(C)OB(c2ccc(Oc3ccc(Oc4ccc(C#N)cc4)cc3C=O)cc2C=O)OC1(C)C]

In one embodiment, the present invention provides use of impurity A, impurity B or impurity E as reference marker for determining the purity of the compound of formula IVa.

In one embodiment, the present invention provides a process for the preparation of crisaborole, wherein the compound of formula IV is obtained in a purity of ≥90%, as determined by HPLC, without use of column chromatography.

In one embodiment, the present invention provides a process for the preparation of crisaborole wherein the compound of formula IV is obtained in a purity of ≥90%, as determined by HPLC, by a process comprising treating the compound of formula IV with a hydrocarbon solvent.

The hydrocarbon solvent may be selected as discussed supra,

In one embodiment, the present invention provides a process for the preparation of crisaborole, wherein the compound of formula IV is obtained in a purity of ≥90%, as determined by HPLC, by a process comprising treating the compound of formula IV with a nonpolar solvent.

The nonpolar solvent may be selected as discussed supra.

In (b) of the above process, the compound of formula IV is reduced to give crisaborole, the compound of formula 1.

In one embodiment, the reaction may be carried out in the presence of a reducing agent selected from the group consisting of hydrides such as sodium borohydride, lithium borohydride, lithium aluminium hydride, sodium cyanoborohydride, sodium triacetoxyborohydride; borane complexes such as borane-tetrahydrofuran, borane-dimethylsulfide, and mixtures thereof. Preferably, the reducing agent selected is sodium borohydride.

The reaction may be stirred for a period of about less than 6 h.

In one embodiment, the reaction is stirred for a period of about less than 3 h.

In another embodiment, the reaction is stirred for a period of about less than 1 h.

In one embodiment, the reaction is stirred for a period of about less than 2 h at a temperature of about −5° C. to about 10° C.

In one embodiment, the reaction mixture of step (b), is worked up by concentrating the reaction mixture, followed by a workup process involving one or more of the following steps:
(i) treating the residue with water, extracting the mixture with an organic solvent and concentrating the organic layer to give crisaborole;
(ii) treating the residue with water and organic solvent, adjusting the pH of the reaction mixture in the range of about 4 to 6 using an acid, separating the two layers and concentrating the organic layer to give crisaborole;
(iii) crystallization with an alcohol solvent to give crisaborole.

The organic solvent may be selected from the group consisting of esters such as methyl acetate, ethyl acetate, n-propyl acetate, tert-butyl acetate and the like; ethers such as diethyl ether, diisopropyl ether, cert-butyl methyl ether, dioxane and the like. Preferably, the organic solvent selected is ethyl acetate.

The acid may be selected from the group consisting of hydrochloric acid, to hydrobromic acid, sulfuric acid, phosphoric acid, acetic acid. Preferably, the acid selected is hydrochloric acid.

The alcohol used for crystallization includes but is not limited to methanol, ethanol, n-propyl alcohol, isopropyl alcohol, n-butyl alcohol, isobutyl alcohol, sec-butyl alcohol, tert-butyl alcohol, n-pentyl alcohol, n-octyl alcohol and the like.

In one embodiment, the step (ii) comprises adjusting the pH of the reaction mixture in the range of about 4 to 6 using an acid at a temperature of about −10° C. to about room temperature.

In another embodiment, the step (ii) comprises adjusting the pH of the reaction mixture in the range of about 4 to 6 using an acid at a temperature of about −10° C. to about 20° C.

In one embodiment, the reaction mixture of step (ii), obtained after adjusting the pH in the range of about 4 to 6 using an acid, is stirred for a period of about less than 6 h.

In another embodiment, the reaction mixture of step (ii), obtained after adjusting the pH in the range of about 4 to 6 using an acid, is stirred for a period of about less than 2 h.

In one embodiment, the reaction mixture of step (ii), obtained after adjusting the pH in the range of about 4 to 6 using an acid, is stirred at a temperature of about −10° C. to about room temperature.

In another embodiment, the reaction mixture of step (ii), obtained after adjusting the pH in the range of about 4 to 6 using an acid, is stirred at a temperature of about −10° C. to about 20° C.

In one embodiment, if the pH of the reaction mixture is less than 4, then the pH of the reaction mixture is adjusted in the range of about 4 to 6 using a base.

The base may be selected from alkali metal carbonate such as sodium carbonate, potassium carbonate, caesium carbonate; alkaline earth metal carbonate; alkali metal bicarbonate such as sodium bicarbonate, potassium bicarbonate; alkaline earth metal bicarbonate; alkali metal hydroxide such as sodium hydroxide, potassium hydroxide; and mixtures thereof.

In one embodiment, in step (b), after reduction, a reaction mixture is obtained, from which crisaborole is isolated by a work-up process comprising the step of adjusting the pH of the reaction mixture in the range of about 4 to 6.

In one embodiment, the work-up process comprises addition of water and a water immiscible organic solvent to generate a biphasic reaction mixture and adjusting the pH of the biphasic reaction mixture in the range of about 4 to 6.

The water immiscible organic solvent may be selected from the group consisting of esters such as methyl acetate, ethyl acetate, n-propyl acetate, tert-butyl acetate and the like; ethers such as diethyl ether, diisopropyl ether, tert-butyl methyl ether, dioxane and the like. Preferably, the organic solvent selected is ethyl acetate.

In one embodiment, the reaction mixture of step (b), is worked up by a process involving the following steps:
(i) concentrating the reaction mixture;
(ii) treating the residue with water and organic solvent;
(iii) adjusting the pH of the reaction mixture in the range of about 4 to 6 using an acid;
(iv) optionally, stirring the reaction mixture for a period of about less than 6 h;
(v) separating the organic layer from the aqueous layer; and
(vi) isolating crisaborole from the organic layer.

The organic solvent and acid may be selected from the group as discussed supra.

In one embodiment, the steps (iii) and (iv) may be carried out at a temperature of about −10° C. to about room temperature.

In another embodiment, the steps (iii) and (iv) may be carried out at a temperature of about −10° C. to about 20° C.

In one embodiment, in step (v), after separating the organic layer from the aqueous layer, the organic layer may be optionally treated with Norit™ charcoal and filtered to get a particle-free solution.

In one embodiment, in step (vi), the crisaborole is isolated by complete evaporation of the solvent or concentrating the solution, cooling the solution if required and filtering the obtained solid. The solution may also be completely evaporated in, for example, a rotavapor, a vacuum paddle dryer or in a conventional reactor under vacuum above about 720 mm Hg, or evaporated by lyophilisation, freeze-drying technique, spray drying, fluid bed drying, flash drying, spin flash drying, thin-film drying.

In one embodiment, the crisaborole obtained by the process described herein, has a purity of ≥99%, as determined by HPLC.

In one embodiment, the crisaborole obtained by the process described herein, has a purity of at least 99.5% and wherein the level of impurity C or impurity D is less than 0.5% w/w relative to the amount of crisaborole, as determined by HPLC

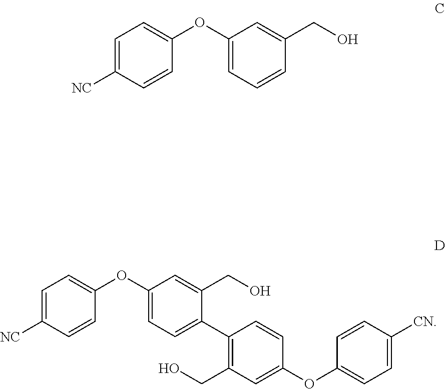 [SMILES: N#Cc1ccc(Oc2cccc(CO)c2)cc1 ; N#Cc1ccc(Oc2ccc(-c3ccc(Oc4ccc(C#N)cc4)cc3CO)c(CO)c2)cc1]

In one embodiment, the crisaborole obtained by the process described herein, has a purity of at least 99.5% and wherein the level of impurity C or impurity D is less than 0.15%, preferably absent, as determined by HPLC.

In one embodiment, the present invention provides crisaborole in a purity of at least 99.5% and wherein the level of impurity C or impurity D is less than 0.15%, as determined by HPLC, by a process wherein in step (b), after reduction, a reaction mixture is obtained, from which crisaborole is isolated by a work-up process comprising the step of adjusting the pH of the reaction mixture in the range of about 4 to 6.

In one embodiment, the work-up process comprises addition of water and a water immiscible organic solvent to generate a biphasic reaction mixture and adjusting the pH of the biphasic reaction mixture in the range of about 4 to 6.

The water immiscible organic solvent may be selected as discussed supra.

In one embodiment, the present invention provides crisaborole in a purity of at least 99.5% and wherein the level of impurity C or impurity D is less than 0.15%, as determined by HPLC, and with a yield of ≥70%, by a process wherein in step (b), after reduction, a reaction mixture is obtained, from which crisaborole is isolated by a work-up process comprising the step of adjusting the pH of the reaction mixture in the range of about 4 to 6.

In one embodiment, the present invention provides a process for the preparation of crisaborole, the process comprising:
(i) treating the compound of formula IV with a hydrocarbon solvent to give the compound of formula IV in a purity of ≥90% and wherein the level of impurity A or impurity B is less than 0.5% w/w relative to the amount of the compound of formula IV, as determined by HPLC;
(ii) reducing the compound of formula (IV) obtained in step (i) to give a reaction mixture from which crisaborole is isolated by a work-up process comprising the step of adjusting the pH of the reaction mixture in the range of about 4 to 6 to give crisaborole in a purity of at least 99.5% and wherein the level of impurity C or impurity D is less than 0.15% w/w relative to the amount of crisaborole, as determined by HPLC.

In another embodiment, the present invention provides a process for the preparation of crisaborole, the process comprising:
(i) treating the compound of formula IV with a nonpolar solvent to give the compound of formula IV in a purity of >90% and wherein the level of impurity A or impurity B is less than 0,5% w/w relative to the amount of the compound of formula IV, as determined by HPLC;
(ii) reducing the compound of formula (IV) obtained in step (i) to give a reaction mixture from which crisaborole is isolated by a work-up process comprising the step of adjusting the pH of the reaction mixture in the range of about 4 to 6 to give crisaborole in a purity of at least 99.5% and wherein the level of impurity C or impurity D is less than 0.15% w/w relative to the amount of crisaborole, as determined by HPLC.

The work-up process is as discussed supra.

In one embodiment, the present invention provides use of impurity C or impurity D as reference marker for determining the purity of the compound of formula I.

In one embodiment, the crisaborole has a purity of ≥99.8% and wherein the level of any single impurity is less than 0.15% w/w of crisaborole, as determined by HPLC.

In one embodiment, the crisaborole obtained by the process described herein, has a purity of at least 99.5% and wherein the level of impurity F or impurity G or impurity H or impurity I or the compound of formula IVa is less than 0.15%, preferably absent, as determined by HPLC

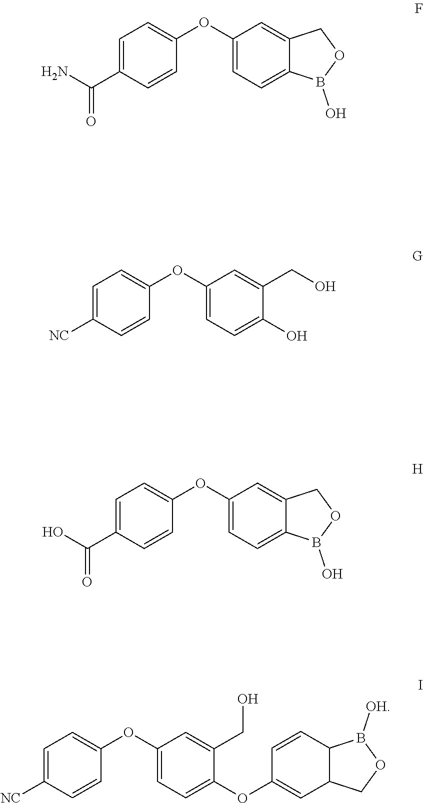 [SMILES: NC(=O)c1ccc(Oc2ccc3c(c2)COB3O)cc1 ; N#Cc1ccc(Oc2ccc(O)c(CO)c2)cc1 ; O=C(O)c1ccc(Oc2ccc3c(c2)COB3O)cc1 ; N#Cc1ccc(Oc2ccc(OC3=CC4COB(O)C4C=C3)c(CO)c2)cc1]

In one embodiment, the present invention provides use of impurity F, impurity G, impurity H or impurity I as reference marker for determining the purity of the compound of formula I.

The present invention provides cri.saborole and the compound of formula IVa obtained by above process, as analyzed by chemical purity using high performance liquid chromatography (HPLC) with the conditions described below:
Reagents and Solvents: o-Phosphoric acid (GR grade), Acetonitrile (Gradient grade),
Methanol (HPLC grade), Water (Milli Q or equivalent)
Chromatographic Conditions:
Apparatus: A High Performance Liquid Chromatograph equipped with quaternary gradient pumps, variable wavelength UV detector attached with data recorder and integrator software.
Column: Eclipse plus C8, 150×4.6 mm, 3,5 μ
Column temperature: 40° C.
Sample Cooler temperature: 25° C.
Mobile Phase A: Buffer
Buffer: 0.1% of o-phosphoric acid in water.
Mobile Phase B: Methanol: Acetonitrile (50: 50, v/v)

| Time (min.) | % Mobile Phase A | % Mobile Phase B |
|---|---|---|
| 0.01 | 75 | 25 |
| 50 | 55 | 45 |
| 65 | 25 | 75 |
| 75 | 25 | 75 |
| 77 | 75 | 25 |
| 85 | 75 | 25 |

Diluent: Acetonitrile: Water (80: 20, v/v
Flow Rate: 1.0 mL/minute
Detection: UV 228nm and 250 nm
Injection Volume: 204
The retention time of the compound of formula IVa is about 25.0 minutes under these conditions.
Relative retention time for impurity A is about 1.26, impurity B is about 2.74 and impurity E is about 1.95 with respect to the compound of formula IVa.
The retention time of crisaborole is about 37.0 minutes under these conditions.
Relative retention time for impurity C is about 0.86, impurity D is about 1.73, impurity F is about 0.49, impurity G is about 0.63, impurity H is about 0.96 and impurity I is about 1.37 with respect to crisaborole.

In one embodiment, the present invention provides a process for the preparation of crisaborole, a compound of formula 1,

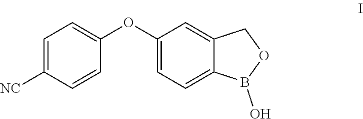 [SMILES: N#Cc1ccc(Oc2ccc3c(c2)COB3O)cc1]

the process comprising:
(a) reacting a compound of formula IIa,

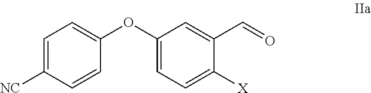

wherein X is selected from the group consisting of Cl, Br, I, OMs, OTf, with a compound of formula III,

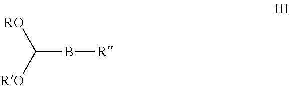

wherein, R″ is H, or B(OR)(OR′);
R and R′ are independently C₁₋₆ alkyl, aryl, or R and R′ together with the oxygen atoms to which they are bonded join to form a 5- or 6-membered ring, wherein the 5- or 6-membered ring is optionally substituted with C₁₋₆ alkyl or fused with aryl, to give a compound of formula IV:

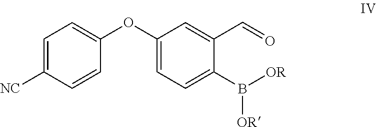

(b) treating the compound of formula IV with a nonpolar solvent; and
(c) reducing the compound of formula IV obtained in step (b) to give crisaborole, the compound of formula 1.

The steps (a), (b) and (c) are carried out as discussed supra.

In one embodiment, the compound of formula IV obtained in step (b), has a purity of

In one embodiment, the compound of formula IVa obtained in step (b) has a purity of ≥90% and wherein the level of impurity A or impurity B is less than 0.5% w/w relative to the amount of the compound of formula IV, as determined by HPLC.

In one embodiment, in step (b), the compound of formula IV is obtained in a purity of ≥90%, as determined by HPLC, without use of column chromatography.

In one embodiment, the crisaborole obtained in step (c) has a purity of at least 99.5% and wherein the level of impurity C or impurity D is less than 0.15% w/w relative to the amount of crisaborole, as determined by HPLC.

In one embodiment, the present invention provides a process for the preparation of crisaborole, a compound of formula I,

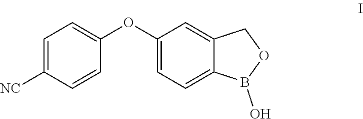 [SMILES: N#Cc1ccc(Oc2ccc3c(c2)COB3O)cc1]

the process comprising:
(a) reacting a compound of formula IIa,

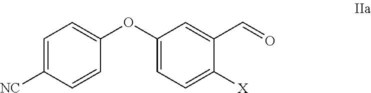

wherein X is selected from the group consisting of Cl, Br, I, OMs, OTf, with a compound of formula. III,

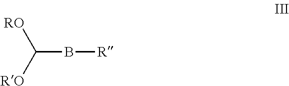

wherein, R″ is H, or B(OR)(OR′);
R and R′ are independently C₁₋₆ alkyl, aryl, or R and R′ together with the oxygen atoms to which they are bonded join to form a 5- or 6-membered ring, wherein the 5- or 6-membered ring is optionally substituted with C₁₋₆ alkyl or fused with aryl, to give a compound of formula IV;

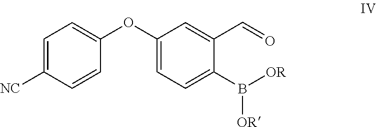

(b) reducing the compound of formula IV to give crisaborole, the compound of formula I, wherein after reduction, a reaction mixture is obtained, from which crisaborole is isolated by a work-up process comprising the step of adjusting the pH of the reaction mixture is in the range of about 4 to 6.

In one embodiment, the work-up process comprises addition of water and a water immiscible organic solvent to generate a biphasic reaction mixture and adjusting the pH of the biphasic reaction mixture in the range of about 4 to 6.

In one embodiment, the crisaborole obtained in step (c) has a purity of at least 99.5% and wherein the level of impurity C or impurity D is less than 0.15% w/w relative to the amount of crisaborole, as determined by HPLC.

In one embodiment, the present invention provides a process for the preparation of crisaborole, a compound of formula

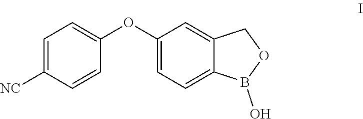 [SMILES: N#Cc1ccc(Oc2ccc3c(c2)COB3O)cc1]

the process comprising:
(a) reacting a compound of formula IIa,

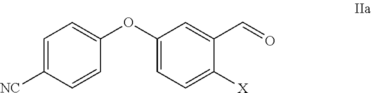

wherein X is selected from the group consisting of Cl, Br, I, OMs, OTf, with a compound of formula III,

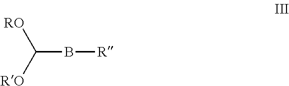

wherein, R″ is H or B(OR)(OR′);
R and R′ are independently C₁₋₆ alkyl, aryl, or R and R′ together with the oxygen atoms to which they are bonded join to form a 5- or 6-membered ring, wherein the 5- or 6-membered ring is optionally substituted with C₁₋₆ alkyl or fused with aryl, to give a compound of formula IV in a purity of ≥90% and wherein the level of impurity A or impurity B is less than 0.5% w/w relative to the amount of the compound of formula IV, as determined by HPLC; and

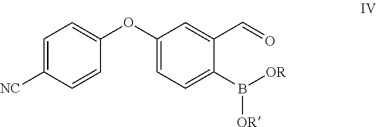

(b) reducing the compound of formula IV to give crisaborole, the compound of formula I in a purity of at least 99.5% and wherein the level of impurity C or impurity D is less than 0.15% w/w relative to the amount of crisaborole as determined by HPLC.

The steps (a) and (b) are carried out as discussed supra.

In one embodiment, the compound of formula IIa is prepared by a process comprising:
(i) reacting a compound of formula VI,

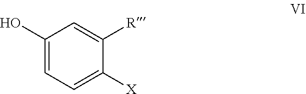

wherein R′″ is CHO or protected derivatives thereof; X is selected from the group consisting of Cl, Br, I, OMs, OTf,
with a compound of formula VII,

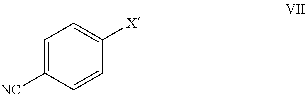

wherein X′ is selected from the group consisting of F, Cl, Br, I, to give the compound of formula II,

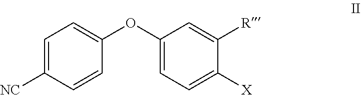

wherein X′″ is CHC pound of formula IIa or protected derivatives thereof and X is as defined above:
(ii) optionally, deprotecting the compound of formula II, wherein R′″≠CHO to give the compound of formula IIa, wherein R′″ is CHO.

The CHO group can be protected as dialkyl acetals such as dimethyl acetal, diethyl acetal; 1,3-dioxanes, 1,3-dioxolanes such as ethylene glycol acetal, neopentyl glycol acetal, 1.3-propanediol acetal, and the like; 1,3-dithianes, 1,3-dithiolanes.

In (i) of the above process, the compound of formula VI is reacted with compound of formula VII to give the compound of formula II.

In one embodiment, the reaction may be carried out in the presence of a base.

A suitable base includes but is not limited to inorganic base such as potassium carbonate, sodium carbonate, potassium bicarbonate, sodium bicarbonate; organic base such as triethylamine, diisopropylethylamine, pyridine; or mixtures thereof. Preferably, the base is selected from inorganic base and more preferably the base is potassium carbonate.

In (ii) of the above process, the compound of formula II, wherein R′″≠CHO is deprotected to give the compound of formula IIa, wherein R′″ is CHO.

In one embodiment, when the CHO group in the compound of formula II is protected as dialkyl acetal, 1,3-dioxane or 1,3-dioxolane, the deprotection is performed using an inorganic acid selected from the group consisting of hydrochloric acid, hydrobromic acid, sulfuric acid, phosphoric acid; organic acid such as p-toluenesulfonic acid.

In one embodiment, the present invention provides a one-pot process for the preparation of crisaborole, the process comprising:
(a) reacting a compound of formula IIa,

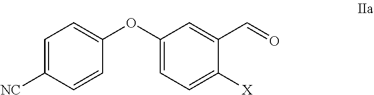

wherein X is selected from the group consisting of Cl, Br, I, OMs, OTf,
with a compound of formula III,

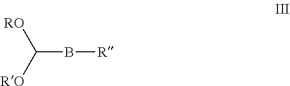

wherein, R″ is H, or B(OR)(OR′);
R and R′ are independently C₁₋₆ alkyl, aryl, or R and R′ together with the oxygen atoms to which they are bonded join to form a 5- or 6-membered ring, wherein the 5- or 6-membered ring is optionally substituted with C₁₋₆ alkyl or fused with aryl, to give a compound of formula IV; and

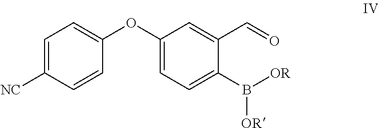

(b) reducing the compound of formula IV to give crisaborole, the compound of formula 1.

The term “one-pot” means the steps referred to are in-situ and the intermediates are not isolated. The term “not isolated” means the intermediates referred to are not separated as a solid.

In one embodiment, the term “one-pot” means the process of the invention is carried out without isolation of the compound of formula IV in the form of a solid compound.

In one embodiment, the present invention provides a process for the preparation of crisaborole, the process comprising reducing the compound of formula IV to give crisaborole, preferably in a one-step conversion directly.

In one embodiment, the present invention provides a process for the preparation of crisaborole, the process comprising reducing the compound of formula IV to give crisaborole, wherein the compound of formula IV is obtained in a purity of ≥90%, as determined by HPLC, without use of column chromatography.

In one embodiment, the present invention provides a process for the preparation of crisaborole, the process comprising reducing the compound of formula IV to give crisaborole, wherein the compound of formula IV is obtained in a purity of ≥90% and wherein the level of impurity A or impurity B is less than 0.5% w/w relative to the amount of the compound of formula IV, as determined by HPLC.

In one embodiment, the present invention provides a process for the preparation of crisaborole, wherein the compound of formula IV is not oxidatively cleaved to form horonic acid derivative, prior to the reduction step.

The present invention provides a process for the preparation of crisaborole, the process comprising:
(a) dissolving crisaborole in an organic solvent to form a solution;
(b) optionally, adding a second solvent to the solution of step (a) to form a mixture;
(c) precipitating out crisaborole from the solution of step (a) or the mixture of step (b); and.
(d) isolating crisaborole obtained in step (c).

In (a) of the above process, crisaborole is dissolved in an organic solvent to form a solution.

In one embodiment, the organic solvent includes but is not limited to esters such as methyl acetate, ethyl acetate, n-propyl acetate, tert-butyl acetate and the like; alcohols such as methanol, ethanol, n-propyl alcohol, isopropyl alcohol, n-butyl alcohol, isobutyl alcohol, sec-butyl alcohol, tert-butyl alcohol, n-pentyl alcohol, n-octyl alcohol and the like, ketones such as acetone, ethyl methyl ketone, methyl isobutyl ketone and the like, ethers such as dimethyl ether, diethyl ether, diisopropyl ether, methyl tert-butyl ether, tetrahydrofuran, dioxane and the like; sultbxides such as dimethyl sulfoxide, or mixtures thereof.

Suitable temperature for dissolution of crisaborole may range from about 20° C. to about 120° C. Preferably, dissolution of crisaborole is at about 25° C. to about 60° C. Stirring may be continued for any desired time period to achieve a complete dissolution of crisaborole. The stiffing time may range from about 30 minutes to about 10 hours, or longer. The solution may be optionally treated with charcoal and filtered to get a particle-free solution.

In (b) of the above process, the second solvent is optionally added to the solution of step (a) to form a mixture.

In one embodiment, the second solvent includes but is not limited to hydrocarbons such as heptane, hexane and the like, water, or mixtures thereof.

In (c) of the above process, crisaborole is precipitated out from the solution of step (a) or the mixture of step (b).

In one embodiment, crisaborole is precipitated out by stirring the solution of step (a) or the mixture of step (b). The stirring time may range from about 30 minutes to about 5 hours, or longer. The temperature may range from about 0° C. to about 85° C. Preferably, the solution is stirred for about 1 hour to about 2 hours at about 10° C. to about 25° C.

In one embodiment, crisaborole is precipitated out from the solution of step (a) or the mixture of step (b) by lvophilisation, freeze-drying technique, spray drying, fluid bed drying, flash drying, spin flash drying, thin-film drying.

In (d) of the above process, crisaborole is isolated from the solution by any method known in the art. The method, may involve any of techniques, known in the art, including filtration by gravity or by suction, centrifugation, and the like.

In one embodiment, the crisaborole obtained is in crystalline form.

In one embodiment, the present invention provides a process for the preparation of crystalline crisaborole characterized by an X-ray powder diffraction (XRPD) to spectrum having peak reflections at about 7.1, 12.3, 14.2, 16.6 and 20.8 +0.2 degrees 2 theta, the process comprising:
(a) dissolving crisaborole in dimethyl sulfoxide to form a solution;
(b) adding water to the solution of step (a) to form a mixture;
(c) precipitating out crisaborole from the mixture of step (b); and
(d) isolating crisaborole obtained in step (c).

In (a) of the above process, crisaborole is dissolved in dimethyl sulfoxide to form a solution.

Suitable temperature for dissolution of crisaborole may range from about 20° C. to about 80° C. Preferably, dissolution of crisaborole is at about 30° C. to about 60° C.

In (b) of the above process, water is added to the solution of step (a) to form a mixture.

Suitable temperature for addition of water may range from about 10° C. to about 60° C. Preferably, dissolution of crisaborole is at about 15° C. to about 50° C.

In (c) of the above process, crisaborole is precipitated out from the mixture of step (b).

In one embodiment, crisaborole is precipitated out by stirring the mixture of step (b). The stirring time may range from about 30 minutes to about 5 hours, or longer. The temperature may range from about 10° C. to about 60° C. Preferably, the solution is stirred for about 1 hour to about 2 hours at about 15° C. to about 35° C.

In (d) of the above process, crisaborole is isolated from the mixture by any method known in the art. The method, may involve any of techniques, known in the art, including filtration by gravity or by suction, centrifugation, and the like.

In one embodiment, the present invention provides crystalline crisaborole characterized by an X-ray powder diffraction (XRPD) spectrum having peak reflections at about 7.1, 12.3, 14.2, 16.6 and 20.8±0.2 degrees 2 theta.

In one embodiment, the present invention provides crystalline crisaborole characterized by an X-ray powder diffraction (XRPD) spectrum having peak reflections at about 7.1, 12.3, 14.2, 16.6 and 20.8±0.2 degrees 2 theta, as depicted in FIG. 1.

In one embodiment, the present invention provides crystalline crisaborole characterized by an X-ray powder diffraction (XRPD) spectrum having peak reflections at about 7.1, 12.3, 14.2, 16.6 and 20.8±0.2 degrees 2 theta, as depicted in FIG. 1 and DSC thermogram having endothermic peak at about 124-128±1° C.

In one embodiment, the present invention provides crystalline crisaborole characterized by an X-ray powder diffraction (XRPD) spectrum having peak reflections at about 7.1, 12.3, 14.2, 16.6 and 20.8±0.2 degrees 2 theta, prepared by a process comprising:
(a) dissolving crisaborole in dimethyl sulfoxide to form a solution;
(b) adding water to the solution of step (a) to form a mixture;
(c) precipitating out crisaborole from the mixture of step (b); and
(d) isolating crisaborole obtained in step (c).

The process steps (a), (b), (c) and (d) are as discussed supra.

In one embodiment, the present invention provides crystalline crisaborole characterized by an X-ray powder diffraction (XRPD) spectrum having peak reflections at about 6.0, 14.0, 15.3, 15.9 and 18.2±0.2 degrees 2 theta.

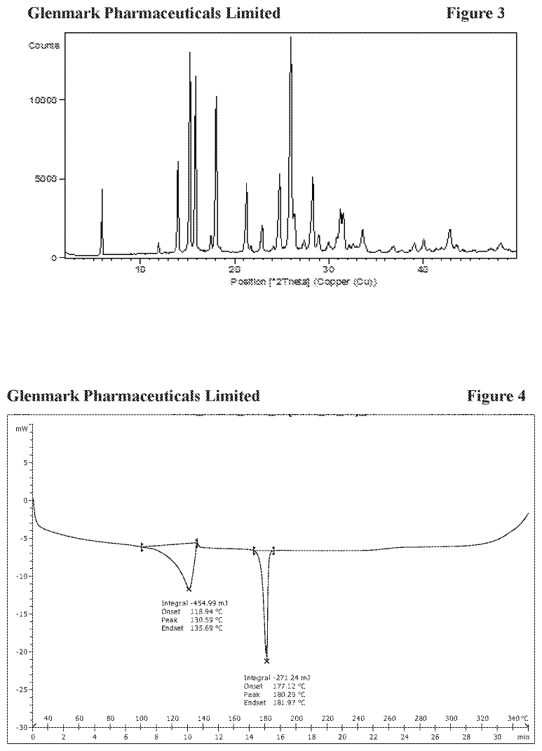

In one embodiment, the present invention provides crystalline crisaborole characterized by an X-ray powder diffraction (XRPD) spectrum having peak reflections at about 6.0, 14.0, 15.3, 15.9 and 18.2±0.2 degrees 2 theta, as depicted in FIG. 3.

In one embodiment, the present invention provides crystalline crisaborole characterized by an X-ray powder diffraction (XRPD) spectrum having peak reflections at about 6.0, 14.0, 15.3, 15.9 and 18.2±0.2 degrees 2 theta, as depicted in FIG. 3 and DSC thermogram having endothermic peak at about 121-131±PC.

In one embodiment, the present invention provides an amorphous form of crisaborole.

In one embodiment, the present invention provides a solid amorphous dispersion of crisaborole.

The term “solid amorphous dispersion” means the dispersion contains crisaborole in a substantially amorphous solid state form. The term “substantially amorphous” means at least 80% of crisaborole in the dispersion is in an amorphous form.

In one embodiment, the solid amorphous dispersion of crisaborole is prepared by lyophilisation, freeze-drying technique, spray drying, fluid bed drying, flash drying, spin flash drying, thin-film drying.

In one embodiment, the present invention provides a solid amorphous dispersion of crisaborole with a pharmaceutically acceptable carrier.

The pharmaceutically acceptable carrier may comprise diluents, adjuvants, disintegrating agents, binders, excipients, lubricants, solubility enhancing agents and the like.

The present invention provides a process for the preparation of solvates of crisaborole, the process comprising:
(a) dissolving crisaborole in a suitable solvent, optionally in presence of additional solvent, to form a solution;
(b) obtaining solvate of crisaborole from the solution of step (a); and
(c) isolating the solvate of crisaborole.

The solvate of crisaborole includes solvate with water, n-propyl alcohol, isopropyl alcohol, n-butyl alcohol, isobutyl alcohol, tert-butyl alcohol, ethylene glycol, ethyl acetate, n-butyl acetate, isobutyl acetate, methyl isobutyl ketone, dioxane, chloroform, dichloromethane, hexane, n-heptane, tolueneV-methyl pyrrolidone, dimethylformamide or dimethyl sulfoxide.

In (a) of the process for the preparation of solvate of crisaborole, crisaborole is dissolved in a suitable solvent, optionally in presence of additional solvent, to form a solution.

The suitable solvent includes water, n-propyl alcohol, isopropyl alcohol, n-butyl alcohol, isobutyl alcohol, tell-butyl alcohol, ethylene glycol, ethyl acetate, n-butyl acetate, isobutyl acetate, methyl isobutyl ketone, dioxane, chloroform, dichloromethane, hexane, n-heptane, toluene, N-methyl pyrrolidone, dimethylformamide or dimethyl sulfoxide.

The additional solvent includes but is not limited to esters such as methyl acetate, ethyl acetate, n-propyl acetate, isopropyl acetate, tert-butyl acetate and the like; hydrocarbons such as toluene, xylene, chlorobenzene, heptane, hexane and the like; ethers such as diethyl ether, diisopropyl ether, methyl tert-butyl ether, tetrahydrofuran, dioxane and the like; ketones such as acetone, ethyl methyl ketone, methyl isobutyl ketone and the like; alcohols such as methanol, ethanol, n-propyl alcohol, isopropyl alcohol, n-butyl alcohol, isobutyl alcohol, tert-butyl alcohol, n-pentyl alcohol, n-octyl alcohol and the like; haloalkanes such as dichloromethane, chloroform, ethylene dichloride and the like; dimethyl sulfoxide; dimethyl acetamide; water; or mixtures thereof.

Suitable temperature for dissolution of crisaborole may range from about 20° C. to about 120° C. Stirring may be continued for any desired time period to achieve a complete dissolution of crisaborole. The stirring time may range from about 30 minutes to about 10 hours, or longer. The solution may be optionally treated with charcoal and filtered to get a particle-free solution.

In (b) of the process for the preparation of solvate of crisaborole, the solvate of crisaborole is obtained from the solution of step (a), the process comprising:
(i) cooling and stirring the solution obtained in step (a); or
(ii) removing the solvent from the solution obtained in step (a); or
(iii) treating the solution of step (a) with an anti-solvent to form a mixture and optionally, cooling and stirring the obtained mixture.

In one embodiment, the solvate of crisaborole is obtained by cooling and stirring the solution of step (a). The stirring time may range from about 30 minutes to about 10 hours, or longer. The temperature may range from about −20° C. to about 30° C.

In one embodiment, the solvate of crisaborole is obtained by removing the solvent from the solution obtained in (a). Removal of solvent may be accomplished by substantially complete evaporation of the solvent; or concentrating the solution, cooling. the solution if required and filtering the obtained solid. The solution may also be completely evaporated in, for example, a rotavapor, a vacuum paddle dryer or in a conventional reactor under vacuum above about 720 mm fig.

In one embodiment, the solvate of crisaborole is obtained by adding an anti-solvent to the solution obtained in (a) to form a mixture and optionally, cooling and stirring the obtained mixture. The stirring time may range from about 30 minutes to about 10 hours, or longer. The temperature may range from about −10° C. to about 120° C.

The anti-solvent is selected such that the solvate of crisaborole is precipitated out from the solution.

The anti-solvent includes but is not limited to esters such as methyl acetate, ethyl acetate, n-propyl acetate, isopropyl acetate, tert-butyl acetate and the like; hydrocarbons such as toluene, xylene, chlorobenzene, heptane, hexane and the like; ethers such as diethyl ether, diisopropyl ether, methyl tert-butyl ether, tetrahydrofuran, dioxane and the like; ketones such as acetone, ethyl methyl ketone, methyl isobutyl ketone and the like; alcohols such as methanol, ethanol, n-propyl alcohol, isopropyl alcohol, n-butyl alcohol, isobutyl alcohol, tert-butyl alcohol, n-pentyl alcohol, n-octyl alcohol and the like; haloalkanes such as dichloromethane, chloroform, ethylene dichloride, and the like; dimethyl sulfoxide; dimethyl acetamide; water; or mixtures thereof.

In (c) of the process for the preparation of solvate of crisaborole, the solvate of crisaborole is isolated by any method known in the art. The method, may involve any of techniques, known in the art, including filtration by gravity or by suction, centrifugation, and the like.

In one embodiment, the solvate of crisaborole is converted to the crystalline forms of the present invention.

In one embodiment, the present invention provides pharmaceutical compositions comprising crisaborole or solvate thereof obtained by the processes herein described, having a D₉₀ particle size of less than about 250 microns, preferably less than about 150 microns, more preferably less than about 50 microns, still more preferably less than about 20 microns, still more preferably less than about 15 microns and most preferably less than about 10 microns.

In one embodiment, the present invention provides pharmaceutical compositions comprising crisaborole or solvate thereof obtained by the processes herein described, having a D₅₀ particle size of less than about 250 microns, preferably less than about 150 microns, more preferably less than about 50 microns, still more preferably less than about 20 microns, still more preferably less than about 15 microns and most preferably less than about 10 microns.

The particle size disclosed here can be obtained by, for example, any milling, grinding, micronizing or other particle size reduction method known in the art to bring the solid state crisaborole or solvate thereof into any of the foregoing desired particle size range.

The examples that follow are provided to enable one skilled in the art to practice the invention and are merely illustrative of the invention. The examples should not be read as limiting the scope of the invention as defined in the features and advantages.

### EXAMPLES

### Example 1

### Preparation of 4-(4-bromo-3-formylphenoxy)benzonitrile

A mixture of 2-bromo-5-hydroxybenzaldehyde (10 g), 4-fluorobenzonitrile (8.9 g) and potassium carbonate (13.6 g) in dimethylformamide (50 mL) was stirred at about 100° C. for about 5 h under nitrogen atmosphere. The reaction mixture was quenched into water at about room temperature, stirred for about 1 h, filtered and dried. The crude product was purified by silica gel column.
Yield: 9 g
HPLC purity: ≥98.5%

### Example 2

### Preparation of 4-[3-formyl-4-(4,4,5,5-tetramethyl-1,3,2-dioxaborolan-2-yl)phenoxyl]benzonitrile

A mixture of 4-(4-bromo-3-formylphenoxy)benzonitrile (25 g), potassium acetate (24.36 g), bis(pinacolato)diborane (21 g) and [1,1′-bis(diphenylphosphino)ferrocene]dichloropalladium(II) (1.25 g) in 1,4-dioxane (250 mL) was stirred at about 80° C. for about 5 h. The reaction mixture was filtered through hyflo bed and the filtrate was concentrated under reduced pressure. Water and ethyl acetate were added to the obtained residue and the mixture was stirred. The two layers were separated and the organic layer was concentrated under reduced pressure and treated with heptane to give 4-[3-formyl-4-(4,4,5,5-tetramethyl-1,3,2-dioxaborolan-2-yl)phenoxy]benzonitrile.
¹H NMR (400 MHz, DMSO-d₆): δ ppm 1.34 (s,12H), 7.18-7.22 (m,2H), 7.41-7.44 (dd,1H), 7.51-7.52 (d,1H), 7.85-7.90 (m,3H), 10.41 (s,1H)
HPLC purity: ≥96.5%; Impurity A: <0.5%; Impurity B: <0.5%
Yield: 21 g (72.7%)

### Example 3

### Preparation of 4-[3-formyl-4-(4,4,5,5-tetramethyl-1,3,2-dioxaborolan-2-yl)phenoxy]benzonitrile

A mixture of 4-(4-bromo-3-formylphenoxy)benzonitrile (25 g), potassium acetate (24.36 g), bis(pinacolato)diborane (21 g) and [1,1′-bis(diphenylphosphino)ferrocene]dichloropalladium(II) (1.25 g) in toluene (250 mL) was stirred at about 80° C. for about 6 h. The reaction mixture was filtered through hyflo bed and the filtrate was concentrated under reduced pressure. Water and ethyl acetate were added to the obtained residue and the mixture was stirred. The two layers were separated and the organic layer was concentrated under reduced pressure and treated with heptane to give 4-[3-formyl-4-(4,4,5,5-tetramethyl-1,3,2-dioxaborolan-2-yl)phenoxy]benzonitrile.

### Example 4

### Preparation of 4-[3-formyl-4-(4,4,5,5-tretramethyl-1,3,2-dioxaborolan-2-yl)phenoxy]benzonitrile

A mixture of 4-(4-bromo-3-formylphenoxy)benzonitrile (25 g), potassium acetate (24.36 g), bis(pinacolato)diborane (21 g) and bis(triphenylphosphine)palladium(II) chloride (1.25 g) in toluene (250 mL) was stirred at about 80° C. for about 6 h. The reaction mixture was filtered through hyflo bed and the filtrate was concentrated under reduced pressure. Water and ethyl acetate were added to the obtained residue and the mixture was stirred. The two layers were separated and the organic layer was concentrated under reduced pressure and treated with heptane to give 4-[3-formyl-4-(4,4,5,5-tetramethyl-1,3,2-dioxaborolan-2-yl)phenoxy]benzonitrile.

### Example 5

### Preparation of 4-[3-formyl-4-(4,4,5,5-tetramethyl-1,3,2-dioxaborolan-2-yl)phenoxy]benzonitrile

A mixture of 4-(4-bromo-3-formylphenoxy)benzonitrile (25 g), potassium acetate (24.36 g), bis(pinacoiato)diborane (21 g) and bis(triphenylphosphine)palladium(II) chloride (1.25 g) in 1,4-dioxane (250 mL) was stirred at about 80° C. for about 5 h. The reaction mixture was filtered through hyflo bed and the filtrate was concentrated under reduced pressure. Water and ethyl acetate were added to the obtained residue and the mixture was stirred. The two layers were separated and the organic layer was concentrated under reduced pressure and treated with heptane to give 4-[3-formyl-4-(4,4,5,5-tetramethyl-1,3,2-dioxaborolan-2-yl)phenoxy ]benzonitrile.

### Example 6

### Preparation of Crisaborole

To a solution of 4-[3-formyl-4-(4,4,5,5-tetramethyl-1,3,2-dioxaborolan-2-yl)phenoxy]benzonitrile (1.0 g) in methanol (130 mL) under nitrogen atmosphere, was added sodium borohydride (1.08 g). The reaction mixture was stirred for about 1 h at about 0° C. to about 15° C. The reaction mixture was concentrated under reduced pressure :to and the residue obtained was dissolved in a mixture of ethyl acetate and water. The pH of the reaction mixture was adjusted in the range of about 4 to 6 with aqueous hydrochloric acid. The organic layer was concentrated under reduced pressure and the product was isolated by, methanol.
HPLC purity: ≥99%; Impurity C: <0.4%; Impurity D: <0.4%
Yield: 5.5 g (76.5%)

### Example 7

### Preparation of Crisaborole

To a solution of 4-[3-formyl-4-(4,4,5,5-tetramethyl-1,3,2-dioxaborolan-2-yl)phenoxy]benzonitrile (5 g) in tetrahydrofuran (30 mL) under nitrogen atmosphere, was added sodium borohydride (0.54 g). The reaction mixture was stirred for about 1 h at about 0° C. to about 15° C. The reaction mixture was concentrated under reduced pressure and the residue obtained was dissolved in a mixture of ethyl acetate and water. The pH of the reaction mixture was adjusted in the range of about 4 to 6 with aqueous hydrochloric acid. The organic layer was concentrated under reduced pressure and the product was isolated by methanol.

### Example 8

### Preparation of Crisaborole

To a solution of crisaborole (2 g) in dimethyl sulfoxide (1.5 mL) was dropwise added water (6 mL). The mixture was stirred for about 1 h. The solid obtained was filtered and dried at about 50° C. to give crisaborole.
HPLC purity: 99.28%
XRPD peaks of crisaborole:

| Pos. | d-spacing | Rel. Int |
|---|---|---|
| [°2Th.] | [Å] | [%] |
| 5.49 | 16.07 | 0.67 |
| 7.10 | 12.44 | 4.67 |
| 10.31 | 8.57 | 0.75 |
| 12.26 | 7.21 | 10.19 |
| 13.21 | 6.69 | 1.66 |
| 14.25 | 6.21 | 19.45 |
| 14.88 | 5.95 | 3.96 |
| 15.49 | 5.71 | 3.53 |
| 15.68 | 5.64 | 4.00 |
| 16.33 | 5.42 | 20.61 |
| 16.64 | 5.32 | 73.71 |
| 17.65 | 5.02 | 39.95 |
| 17.96 | 4.93 | 10.58 |
| 18.41 | 4.81 | 11.38 |
| 18.77 | 4.72 | 3.72 |
| 19.65 | 4.51 | 6.25 |
| 19.93 | 4.45 | 2.96 |
| 20.83 | 4.26 | 100.00 |
| 21.41 | 4.14 | 33.27 |
| 21.79 | 4.07 | 39.04 |
| 22.56 | 3.94 | 64.74 |
| 23.11 | 3.84 | 27.59 |
| 23.50 | 3.78 | 10.17 |
| 23.83 | 3.73 | 8.09 |
| 24.05 | 3.70 | 6.70 |
| 24.80 | 3.58 | 29.23 |
| 26.03 | 3.42 | 13.87 |
| 26.38 | 3.37 | 11.98 |
| 26.54 | 3.35 | 9.41 |
| 27.00 | 3.30 | 9.70 |
| 27.43 | 3.25 | 15.32 |
| 27.73 | 3.21 | 31.68 |
| 27.95 | 3.19 | 30.56 |
| 28.70 | 3.10 | 7.27 |
| 30.09 | 2.96 | 8.23 |
| 30.94 | 2.88 | 4.19 |
| 31.48 | 2.84 | 5.54 |
| 31.97 | 2.79 | 2.96 |
| 33.62 | 2.66 | 3.97 |
| 34.21 | 2.62 | 3.33 |
| 34.90 | 2.57 | 3.79 |
| 37.30 | 2.41 | 8.59 |
| 38.73 | 2.32 | 2.33 |
| 39.73 | 2.26 | 2.53 |

### Example 9

### Preparation of Crisaborole

To a solution of crisaborole (2 g) in acetone (6 mL) was dropwise added water (12 mL) at about 25° C. The mixture was stirred for about 2 h at about 25° C. The solid obtained was filtered and dried at about 50° C. to give crisaborole.
HPLC purity: 99.74%; Impurity C: <0.1%; Impurity D: <0.1%
Compound of formula IVa: <0.05%

### Example 10

### Preparation of Crisaborole

To a solution of crisaborole (2 g) in ethyl acetate (8 mL) at about 60° C., was dropwise added heptane (4 mL). The mixture was stirred for about 1 h at about 25° C. The solid obtained was filtered at about 25° C. and dried at about 50° C. to give crisaborole.
HPLC purity: 99.91%
XRPD peaks of crisaborole:

| Pos. | d-spacing | Rel. Int. |
|---|---|---|
| [°2Th.] | [Å] | [%] |
| 5.97 | 14.78 | 30.64 |
| 11.99 | 7.37 | 5.13 |
| 14.03 | 6.30 | 42.24 |
| 15.27 | 5.80 | 92.40 |
| 15.93 | 5.56 | 80.53 |
| 17.51 | 5.06 | 7.60 |
| 18.09 | 4.90 | 70.94 |
| 18.49 | 4.79 | 2.46 |
| 21.32 | 4.16 | 32.29 |
| 21.83 | 4.07 | 2.46 |
| 22.94 | 3.87 | 12.01 |
| 24.13 | 3.68 | 2.35 |
| 24.79 | 3.59 | 35.20 |
| 26.02 | 3.42 | 100.00 |
| 26.42 | 3.37 | 15.84 |
| 27.43 | 3.25 | 4.78 |
| 28.31 | 3.15 | 35.14 |
| 28.97 | 3.08 | 7.53 |
| 29.96 | 2.98 | 4.21 |
| 30.84 | 2.89 | 6.10 |
| 31.27 | 2.86 | 20.18 |
| 31.60 | 2.83 | 17.00 |
| 32.19 | 2.78 | 3.13 |
| 32.64 | 2.74 | 3.59 |
| 33.60 | 2.66 | 10.79 |
| 35.36 | 2.53 | 1.51 |
| 36.95 | 2.43 | 2.52 |
| 37.83 | 2.37 | 0.76 |
| 39.14 | 2.30 | 4.20 |
| 40.11 | 2.2 | 6.73 |
| 40.65 | 2.21 | 1.52 |
| 41.41 | 2.18 | 1.62 |
| 41.99 | 2.15 | 2.08 |
| 42.74 | 2.11 | 8.65 |
| 42.91 | 2.10 | 10.73 |
| 43.62 | 2.07 | 2.88 |

### Example 11

### Preparation of Crisaborole

Crisaborole (2 g) was dissolved in methanol (40 mL) at about 65° C. The mixture was stirred for about 2 h at about at about 25° C. The solid obtained was filtered at about 25° C. and dried at about 50° C. to give crisaborole.
HPLC purity: 99.97%

### Example 12

### Preparation of Crisaborole

Crisaborole (2 g) was dissolved in ethyl acetate (8 mL) at about 65° C. The mixture was stirred for about 1.5 h at about 25° C. The solid obtained was filtered at about 25° C. and dried at about 50° C. to give crisaborole.
HPLC purity: 99.85%
XRPD peaks of crisaborole: 6.0, 14.0, 15.3, 15.9, 18.2±0.2 degrees 2 theta

### Example 13

### Preparation of Crisaborole

Crisaborole (2 g) was dissolved in isopropyl acetate (12 mL) at about 65° C. The mixture was stirred for about 1.5 h at about 25° C. The solid obtained was filtered at about 25° C. and dried at about 50° C. to give crisaborole.
HPLC purity: 99.9%
XRPD peaks of crisaborole: 6.0, 14.0, 15.3, 15.9, 18.2±0.2 degrees 2 theta

### Example 14

### Preparation of Crisaborole

To a solution of crisaborole (5 g) in tetrahydrofuran (15 mL) was added water (40 mL) at about 25° C., The mixture was stirred for 1 h at about 25° C.The solid obtained was filtered and dried at about 50° C. to give crisaborole.
HPLC purity: 99.08%
XRPD peaks of crisaborole: 6,0, 14.0, 15.3, 15.9,18.2±0.2 degrees 2 theta

### Example 15

### Preparation of 4-(4-bromo-3-formylphenoxy)benzonitrile

A mixture of 2-bromo-5-hydroxybenzaidehyde (50 g), 4-fluorobenzonitrile (75.31 g) and potassium carbonate (103 g) in dimethylformamide (500 mL) was stirred at about 75° C. to about 85° C. for about 20 h. The reaction mixture was filtered and the filtrate was quenched with water at about room temperature, stirred for about 2 h, filtered and dried, The crude product was purified by ethyl acetate.
Yield: 50 g
HPLC purity: ≥99%

### Example 16

### Preparation of 4-[3-formyl-4-(4,4,5,5-tetramethyl-1,3,2-dioxaborolan-2-yl)phenoxy]benzonitrile

A mixture of 4-(4-bromo-3-formylphenoxy)benzonitrile (100 g), potassium acetate (97.45 g), bis(pinacolato)diborane (100 g) and [1,1′-bis(diphenylphosphino)ferrocene]dichloropalladium(II) (1 g) in 1,4-dioxane (500 mL) was stirred at about 65° C. to about 70° C. for about 8 h. The reaction mixture was quenched with water at about room temperature and stirred for about 2 h, filtered and dried. To the solid obtained, was added n-heptane. The mixture was stirred at a temperature of about 85° C. to about 90° C. for about 2 h. The reaction mixture was cooled to about 75° C. to about 85° C., filtered, washed with hot n-heptane. The filtrate was cooled to about 0° C. to about 10° C. and stirred for about 1 h. The solid obtained was filtered and dried at about 45° C. to about 50° C.
Yield: 85 g (73.5%)
HPLC purity: ≥98.5%; Impurity A: <0.15%; Impurity B: <0.3%

### Example 17

### Preparation of Crisaborole

To a solution of 4-[3-formyl-4-(4,4,5,5-tetramethyl-1,3,2-dioxaborolari-2-yl)phenoxylbenzonitrile (100 g) in methanol (1500 mL) under nitrogen atmosphere, was added sodium borohydride (10.8 g) at about −5° C. to about 10° C. The reaction mixture was stirred for about ih at about 0° C. to about 10° C. The reaction mixture was concentrated under reduced pressure at about below 45° C. and the residue obtained was dissolved in a mixture of ethyl acetate and water. The reaction mixture was cooled to about 10° C. to about 20° C. The pH of the reaction mixture was adjusted in the range of about 4 to about 6 with aqueous hydrochloric acid at about the same temperature and stirred for about 30 min to about 45 min. The two layers were separated and the organic layer was treated with concentrated under reduced pressure at about below 45° C. and degassed at about the same temperature.

The product was isolated by mixture of methanol/water and then further treated with dimethyl sulfoxide/water. The wet product was dried at about 45° C. to about 55° C. HPLC purity: ≥99.9%; Impurity C: <0.05%; Impurity D: <0,05%; Impurity F: Not detected; Impurity G: Not detected; Impurity H: Not detected; Impurity I: 0.01% Yield: 55 g (76.5%)

### Example 18

### Preparation of Crisaborole

A mixture of crisaborole (100 g) in dimethyl sulfoxide (165 g) was heated to about 40° C. to about 50° C. to get a clear solution. The mixture was cooled to about 20° C. to about 30° C. and water (1000 mL) was added to it. The mixture was stirred for about 1 h. The solid obtained was filtered and dried at about 45° C. to about 50° C. to give crisaborole.
HPLC purity: 99.9%
XRD peaks of crisaborole: 7.1, 12.3, 14.2. 16.6 and 20.8±0.2 degrees 2 theta

### Example 19

### Preparation of Crisaborole

A mixture of crisaborole (100 g) in ethyl acetate (1000 mL) was heated to about 40° C. to about 50° C. for about 20 min. The mixture was treated with Noritmi charcoal and stirred for about 1 h at about the same temperature. The mixture was filtered at about 40° C. to about 50° C. The filtrate was concentrated under reduced pressure at about below 50° C. and degassed at about the same temperature.
XRD peaks of crisaborole: 7.09, 12.26, 14.27, 16.64 and 20.68±0.2 degrees 2 theta

### Example 20

### Preparation of Crisaborole

To a solution of 4-[3-formyl-4-(4,4,5,5-tetramethyl-1,3,2-dioxaborolan-2-yl)phenoxylbenzonitrile (100 g) in methanol (1500 mL) under nitrogen atmosphere, was added sodium borohydride (10.8 g) at about −5° C. to about 10° C. The reaction mixture was stirred for about 1 h at about 0° C. to about 10° C. The reaction mixture was concentrated under reduced pressure at about below 45° C. and the residue obtained was dissolved in a mixture of ethyl acetate and water. The reaction mixture was cooled to about 10° C. to about 20° C. The pH of the reaction mixture was adjusted in the range of about 4 to about 6 with aqueous hydrochloric acid at about the same temperature and stirred for about 30 min to about 45 min. The two layers were separated and the organic layer was treated with concentrated under reduced pressure. To the obtained residue, methanol and water were added at about below 45° C. The mixture was heated to about 60° C. to about 70° C. and stirred for about 30min. The mixture was cooled to about 20° C. to about 30° C. and stirred for about 2 h at about the same temperature. The solid obtained was filtered and dried.
XRD peaks of crisaborole: 7.09, 12.26, 14.27, 16.64 and 20.68±0.2 degrees 2 theta

1. A process for the preparation of crisaborole, a compound of formula I, 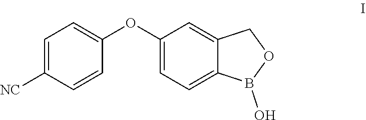 [SMILES: N#Cc1ccc(Oc2ccc3c(c2)COB3O)cc1]
the process comprising:
(a) reacting a compound of formula IIa, 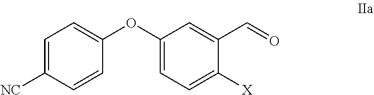
wherein X is selected from the group consisting of Cl, Br, I, OMs, and OTf, with a compound of formula III, 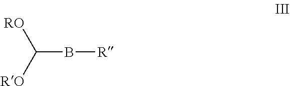
wherein, R″ is H, or B(OR)(OR′);
R and R′ are independently C₁₋₆ alkyl, aryl, or R and R′ together with the oxygen atoms to which they are bonded join to form a 5- or 6-membered ring, wherein the 5- or 6-membered ring is optionally substituted with C₁₋₆ alkyl or fused with aryl,
to give a compound of formula IV; and 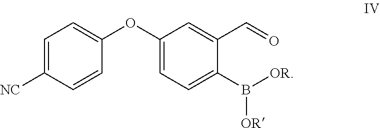
(b) reducing the compound of formula TV to give crisaborole, the compound of formula I, wherein, in step (b), after reducing the compound of formula IV, a reaction mixture is obtained, from which crisaborole is isolated by a work-up process comprising the step of adjusting the pH of the reaction mixture in the range of about 4 to 6.

2. The process of claim 1, wherein X is Br; R″ is B(OR)(OR′); and R and R′ together with the oxygen atoms to which they are bonded join to form a 5-membered ring substituted with C₁ alkyl groups.

3. The process of claim 1, wherein step (a) is carried out in the presence of a metal catalyst.

4. The process of claim 3, wherein the metal catalyst is selected from the group consisting of Pd(PPh₃)₄, PdCl₂(PPh₃)₂, PdCl₂(dppf), Pd(OAc)₂, NiCl₂(PPh₃)₂, PdCl₂(dppb), and mixtures thereof.

5. The process of claim 1, wherein the compound of formula IV obtained in step (a) is treated with a hydrocarbon solvent.

6. The process of claim 1, wherein the compound of formula IV obtained in step (a) is in a purity of ≥90%, as determined by HPLC.

7. The process of claim 6, wherein the compound of formula IV is obtained, wherein the level of impurity A or impurity B is less than 0.5% w/w relative to the amount of the compound of formula IV, as determined by HPLC

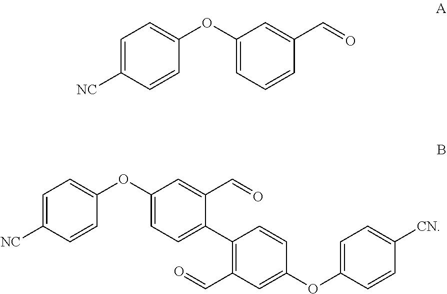 [SMILES: N#Cc1ccc(Oc2cccc(C=O)c2)cc1 ; N#Cc1ccc(Oc2ccc(-c3ccc(Oc4ccc(C#N)cc4)cc3C=O)c(C=O)c2)cc1]

8. The process of claim 1, wherein step (b) is carried out in the presence of a reducing agent selected from the group consisting of sodium borohydride lithium borohydride, lithium aluminium hydride, sodium cyanoborohydride, sodium triacetoxyborohydride, borane-tetrahydrofuran, borane-dimethylsulfide, and mixtures thereof.

9. (canceled)

10. The process of claim 1, wherein the work-up process comprises addition of water and a water immiscible organic solvent to generate a biphasic reaction mixture and adjusting the pH of the biphasic reaction mixture in the range of about 4 to 6.

11. The process of claim 1, wherein the crisaborole obtained is in a purity of at least 99.5% and wherein the level of impurity C or impurity D is less than 0.15% w/w relative to the amount of crisaborole, as determined by HPLC

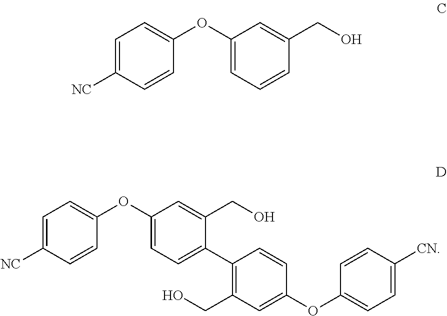 [SMILES: N#Cc1ccc(Oc2cccc(CO)c2)cc1 ; N#Cc1ccc(Oc2ccc(-c3ccc(Oc4ccc(C#N)cc4)cc3CO)c(CO)c2)cc1]

12. The process of claim 1, wherein the compound of formula IIa is prepared by a process comprising:
(i) reacting a compound of formula VI, 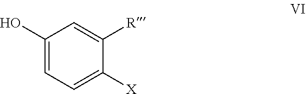
wherein R′″ is CHO or protected derivatives thereof; X is selected from the group consisting of Cl, Br, I, OMs, and OTf,
with a compound of formula VII, 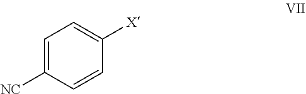
wherein X′ is selected from the group consisting of F, Cl, Br, and I, to give the compound of formula II, 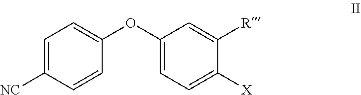
wherein R′″ is CHO or protected derivatives thereof and X is as defined above; and
(ii) optionally, deprotecting the compound of formula II, wherein R′″≠CHO to give the compound of formula IIa, wherein R′″ is CHO.

13. The process of claim 12, wherein R′″ is CHO; X is Br; and X′ is F.

14. The process of claim 12, wherein step (i) is carried out in the presence of a base,

15. The process of claim 14, wherein the base is selected from the group consisting of potassium carbonate, sodium carbonate,potassium bicarbonate, sodium bicarbonate, triethylamine, diisopropylethylamine pyridine, and mixtures thereof.

16. A process for the preparation of crisaborole, the process comprising:
(a) dissolving crisaborole in an organic solvent to form a solution;
(b) optionally, adding a second solvent to the solution of step (a) to form a mixture;
(c) precipitating out crisaborole from the solution of step (a) or the mixture of step (b); and
solating crisaborole obtained in step (c).

17. The process of claim 16, wherein the organic solvent is selected from esters, alcohols, ketones, ethers, sulfoxides, or mixtures thereof.

18. The process of claim 16, wherein the second solvent is selected from hydrocarbons, water, or mixtures thereof.

19. The process of claim 16, wherein the crisaborole obtained is in a purity of at least 99.5%, as determined by HPLC.

20. The process of claim 16,herein the crisaborole obtained is in crystalline form.

21. The process of claim 16, wherein the crisaborole obtained is in amorphous form.
